(19) United States
(12) Patent Application Publication
(10) Pub. No.: US 2020/0324535 A1
(43) Pub. Date: Oct. 15, 2020

(54) COATING COMPOSITIONS

(71) Applicant: Hewlett-Packard Development Company, L.P., Spring, TX (US)

(72) Inventors: Fereshteh KHORRAMI, San Diego, CA (US); Beverly CHOU, San Diego, CA (US); Tao CHEN, San Diego, CA (US); Jesse DAWN, San Diego, CA (US)

(73) Assignee: Hewlett-Packard Development Company, L.P., Spring, TX (US)

(21) Appl. No.: 16/768,516

(22) PCT Filed: Mar. 9, 2018
(86) PCT No.: PCT/US2018/021688

§ 371 Date: May 29, 2020

(51) Int. Cl. B32B 29/06; C09D 1/00; B32B 3/28; B32B 29/08

(52) U.S. Cl. CPC B32B 29/06; C09D 1/00; C08K 13/02; B32B 29/08; B32B 3/28

(57) ABSTRACT

The present disclosure is drawn to coating compositions that can include an inorganic pigment, a non-ionic surfactant, latex particles, a polyvinyl alcohol, and a cationic fixing agent. The inorganic pigment can be included in an amount from 60 wt % to 90 wt % by dry weight. The latex particles can include a styrene-butadiene copolymer, and can be present in an amount of 4 wt % to less than 10 wt % by dry weight. The polyvinyl alcohol can have a weight average molecular weight of 150,000 Mw to 400,000 Mw.

### BACKGROUND

Corrugated linerboard or containerboard packaging is often used as a packaging material. This cellulose fiber-based material includes a fluted medium bonded to one or two flat liner paper faces. The fluted medium and the liner paper are usually made of Kraft pulp. In a typical manufacturing process for corrugated paperboard packaging materials, the fluted medium is first formed by heating and moistening a sheet of corrugating medium and then forming the flute pattern in the sheet using geared wheels. The fluted medium is then bonded using an adhesive to one sheet of liner paper for single-faced corrugated linerboard, or between two sheets of liner paper for double-faced corrugated linerboard or containerboard

Liners for corrugated containerboard are often Kraft brown liners, bleached liners, or white top liners. Printing on the liners is often performed using offset or flexographic printing processes before or after the containerboard has been corrugated.

### BRIEF DESCRIPTION OF THE DRAWINGS

Additional features of the disclosure are set forth in the detailed description which follows, taken in conjunction with the accompanying drawings, which together illustrate, by way of example, features of the present technology.

FIG. 1 is a cross-sectional view of an example coated base liner, as well as a schematic showing assembly with a fluted medium and backing liner to form a corrugated packaging assembly in accordance with an example of the present disclosure;

FIG. 2 is a cross-sectional view of an example coated liner after printing in accordance with an example of the present disclosure; and

FIG. 3 is a flowchart of an example method of formulating a coating composition in accordance with the present disclosure.

Reference will now be made to several examples that are illustrated herein, and specific language will be used herein to describe the same. It will nevertheless be understood that no limitation of the scope of the disclosure is thereby intended.

### DETAILED DESCRIPTION

The present disclosure is drawn to coating compositions for corrugated packaging liners. In one example, a coating composition can include inorganic pigment, a non-ionic surfactant, latex particles, a polyvinyl alcohol, and a cationic fixing agent. The inorganic pigment can be included in an amount from 60 wt % to 90 wt % by dry weight. The latex particles can include a styrene-butadiene copolymer, and can be included in an amount of 4 wt % to less than 10 wt % by dry weight. The polyvinyl alcohol can have a weight average molecular weight of 150,000 Mw to 400,000 Mw. In further examples, the inorganic pigment can be included in an amount from 70 wt % to 90 wt % by dry weight. The polyvinyl alcohol can be included in an amount from 1 wt % to 4 wt % by dry weight. The cationic fixing agent can be present in an amount from 6 wt % to 15 wt %. In a further example, the polyvinyl alcohol can be included in the coating composition in an amount from 1 wt % to 2 wt % by dry weight. In another example, the coating composition can also include a second polyvinyl alcohol having a weight average molecular weight of 20,000 Mw to 130,000 Mw in an amount from 0.5 wt % to 2 wt % by dry weight. In another example, the styrene-butadiene copolymer of the latex particles can be a carboxylated styrene-butadiene copolymer. In yet another example, the coating composition may not include a plastic pigment or a wax. In a further example, the non-ionic surfactant can be a fatty alcohol polyglycol ether.

In another example, a coated liner for corrugated packaging can include a base liner and a coating layer on the base liner. The coating layer can include an inorganic pigment, a non-ionic surfactant, latex particles, a polyvinyl alcohol, and a cationic fixing agent. The latex particles can include a styrene-butadiene copolymer, and can be present in an amount of 4 wt % to 10 wt % by dry weight. The polyvinyl alcohol can have a weight average molecular weight of 150,000 Mw to 400,000 Mw. In one specific example, the coated liner can be attached a fluted medium opposite a backing liner. In another example, the coating layer can have a coating weight of 4 gsm to 20 gsm. In other examples, the coating layer can be a single coating layer without a second coating layer applied thereon. In further examples, the inorganic pigment can be present in the coating layer in an amount from 70 wt % to 90 wt % by dry weight. The polyvinyl alcohol can be present in an amount from 1 wt % to 4 wt % by dry weight. The cationic fixing agent can be present in an amount from 6 wt % to 15 wt % by dry weight.

The present disclosure also extends to methods of formulating coating compositions. In one example, a method of formulating a coating composition can include dispersing an inorganic pigment in water and non-ionic surfactant to form a pigment dispersion. The amount of inorganic pigment can be from 60 wt % to 90 wt % by dry weight with respect to a final weight of the coating composition The water can be admixed first, followed by the non-ionic surfactant, or both can be added at the same time, or the non-ionic surfactant can be added first followed by the water. Latex particles can then be mixed into the pigment dispersion. The latex particles can include a styrene-butadiene copolymer and can be included in an amount from 4 wt % to less than 10 wt % by dry weight with respect to the final weight of the coating composition. A polyvinyl alcohol can also be mixed into the pigment dispersion (before or after the latex particles, or at the same time). The polyvinyl alcohol can have a weight average molecular weight of 150,000 Mw to 400,000 Mw. A cationic fixing agent can be mixed into the pigment dispersion after the latex particles and the polyvinyl alcohol. The method can include mixing the inorganic pigment in an amount from 70 wt % to 90 wt % by dry weight. The polyvinyl alcohol can be included in an amount from 1 wt % to 4 wt % by dry weight. The cationic fixing agent can be included in an amount from 6 wt % to 15 wt % by dry weight. In another example, the cationic fixing agent can be added to the mixture at a rate that is slower than rates of addition of the latex particles and the polyvinyl alcohol.

In certain examples, the coated liners described herein can be printed upon using inkjet printing. The coating composition can form an ink receiving coating layer on the liner to increase the image quality of images printed on the liner. In many cases, commercial or industrial inkjet printing presses can include fixed printheads and a moving media web to achieve high speed printing, e.g., digital printing press or other high speed printers, such as the HP T400S Web Press® or the HP T1100 Web Press®, which can print at rates from 100 feet per minute to 1,000 feet per minute. Inkjet printheads can use several methods of forming ink droplets, such as forcing ink through nozzles using thermal ejection, piezoelectric pressure, or redirecting a continuous stream of droplets in continuous inkjet printing. Such inkjet presses can often be used to print images and text on coated liners and the printed liners can then be used to make packaging materials such as corrugated cardboard boxes and so on. In other examples, the coated liners described herein can be printed upon using other printing methods such as offset printing or flexographic printing.

The coating compositions and coated liners described herein can provide good image quality and mechability of images printed on the coated liners. As used herein, “mechability” refers to the ability of a printed medium to go through harsh mechanical processes such as being wound on rollers, stacked with other media, rubbing, and so on without damaging the printed image. In many cases, a coated liner as described herein can be fed through a series of rollers with varying levels of hygiene and dryers at various speeds and temperatures. Depending on the speed at which the liner is fed through the printer and dryers, the drying time may be short. In some cases ink that has not dried can be transferred off the liner onto hot rollers, which can degrade image quality. Although overprint varnish can be added to a printed liner to protect the printed image, the printed liner can still be subject to harsh environments before application of the overprint varnish. Therefore, the coating compositions described herein can be useful for providing good mechability to the printed image even before the overprint varnish is applied.

As used herein, “image quality” can encompass several specific image properties, such as coalescence, optical density, bleeding, gloss, and so on. The coating compositions described herein can provide particularly good coalescence. Ink coalescence occurs when ink droplets do not absorb sufficiently into the surface of a medium and the droplets then coalesce one with another. This coalescence results in an undesirable non-uniform appearance of the printed ink. Thus, good image quality can include a low level of coalescence.

In some examples, the coating compositions described herein can include a high molecular weight polyvinyl alcohol, such as polyvinyl alcohol having a weight average molecular weight of 150,000 Mw to 400,000 Mw. The high molecular weight polyvinyl alcohol can be used instead of a lower molecular weight polyvinyl alcohol, e.g., from 20,000 Mw to 130,000 Mw, in whole or in part. In some cases, coating compositions for packaging liners may include latexes and crosslinkers to increase mechability. However, the high molecular weight polyvinyl alcohols described herein can, in some examples, allow for a reduction in the amount of latex used and a reduction or elimination of the crosslinker used. Because latex and crosslinkers can sometimes be unpredictable and have negative impacts on coating compositions, removing the crosslinker and reducing the amount of latex can provide a coating composition that is more consistent with less negative effects. Furthermore, in some examples a smaller amount of high molecular weight polyvinyl alcohol can be used compared to the amount of low molecular weight polyvinyl alcohol that can achieve comparable mechability levels.

In addition to providing good mechability, the coating compositions described herein can also provide low levels of ink coalescence. The coating can absorb and fix ink quickly, which can prevent ink droplets from coalescing on the surface of the coated liner. In some examples, including a styrene butadiene latex and a cationic fixing agent in the coating composition can contribute to good coalescence levels. In other examples, a plastic pigment and a wax may be used to increase durability of the printed image. However, removing the plastic pigment and wax can help to reduce coalescence. The coating compositions described herein can provide adequate durability without the plastic pigment or wax, and this can also provide low levels of coalescence.

In various examples, a coating composition can include an inorganic pigment. In some examples, the inorganic pigment can include calcined clay, modified calcium carbonate, fine or ultra-fine ground calcium carbonate (GCC), precipitated calcium carbonate (PCC), or combinations thereof. In one example, the inorganic pigment can include calcined clay, modified calcium carbonate (MCC), ultra-fine ground calcium carbonate (GCC), precipitated calcium carbonate (PCC), or combinations thereof. In another example, the inorganic pigment can include calcined clay, modified calcium carbonate (MCC), ultra-fine ground calcium carbonate (GCC), or combinations thereof.

In one example, the inorganic pigment can include the calcined clay KAOCAL® from Thiele Kaolin Company (Sandersville, Ga.) having a particle size distribution of about 83-92% particles finer than 2 μm. In further examples, the inorganic pigment can include ground calcium carbonate such as Hydrocarb® 60 (a fine ground calcium carbonate having a solids content of about 74% and a median diameter of about 1.4 μm) or Hydrocarb® 90 (an ultrafine ground calcium carbonate having a solids content of about 76% and a median diameter of about 0.7 μm), both available from Omya North America (Cincinnati, Ohio).

In further examples, the inorganic pigment can be ground calcium carbonate; or a mixture of calcined clay and fine ground calcium carbonate; or a mixture of calcined clay and ultrafine ground calcium carbonate; or a mixture of calcined clay and fine ground and ultrafine ground calcium carbonate. In one example, the mixture can contain, by dry weight, at least about 50% of fine and/or ultrafine ground calcium carbonate. In certain examples, the inorganic pigment of the coating composition can include an ultrafine ground calcium carbonate (having a median particle size of about 0.7 μm), calcined clay (having a particle size distribution of about 83-92% particles finer than 2 μm), and/or a combination thereof.

In some examples, the inorganic pigment can have a median particle size ranging from about 0.5 μm to about 5 μm. In another example, the inorganic pigment can have a median particle size ranging from about 0.5 μm to about 2 μm. In still other examples, the inorganic pigment can have a median particle size ranging from about 0.75 μm to about 2 μm, or a median particle size ranging from about 0.5 μm to about 1 μm. As used herein, “particle size” refers to the diameter of a substantially spherical particle (i.e., a spherical or near-spherical particle having a sphericity of >0.84), or the average diameter of a non-spherical particle (i.e., the average of multiple diameters across the particle).

In certain examples, the inorganic pigment can be present in the coating composition in an amount ranging from about 60 wt % to about 90 wt % or from about 70 wt % to about 90 wt % by dry weight based on the total dry weight of the coating composition.

The coating compositions described herein can also include a non-ionic surfactant. As used herein, “non-ionic surfactant” refers to a surfactant that does not have an ionic charge at the hydrophilic end of the surfactant molecule. In certain examples, the non-ionic surfactant can include an ethopropoxylated polyarylphenol, an ethoxylated tristyrylphenol, a fatty alcohol polyglycol ether, or a combination thereof. Specific examples of non-ionic surfactants can include Soprophor® 796/p from Solvay; Soprophor® S/25 from Solvay; Dehypon® E, Dehypon® GRA, Dehypon® KE or Dehypon® WET, Disponil® AFX 4030 or 4050, or Plurafac® LF 7319 (all from BASF Corp.).

In certain examples, the non-ionic surfactant can be present in an amount from 0.01 wt % to 2 wt % by dry weight based on the total dry weight of the coating composition. In further examples, the non-ionic surfactant can be present in an amount from 0.05 wt % to 1 wt % by dry weight, or from 0.1 wt % to 0.5 wt % by dry weight.

The coating compositions can also include latex particles. The latex particles can include a styrene-butadiene copolymer. As used herein, the term “latex” refers to a polymer that is capable of being dispersed in an aqueous medium. The latex may act as a binder in the coating composition. In an example, the latex can be present in the coating composition in an amount ranging from 4 wt % to less than 10 wt % by dry weight based on the total dry weight of the coating. In another example, the latex can be present in an amount from 6 wt % to 8 wt % by dry weight.

In certain examples, styrene-butadiene latex particles can be present together with another type of latex particle. In further examples, the latex particles can include a styrene-butadiene copolymer together with another polymer or copolymer. In various examples, additional polymers, copolymers, and types of latex particles can be formed from monomers such as vinyl monomers, allylic monomers, olefin monomers, unsaturated hydrocarbon monomers, or combinations thereof.

Classes of vinyl monomers can include vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, or mixtures of two or more of the above, for example. The term “(meth) acrylic latex” can include polymers of acrylic monomers, polymers of methacrylic monomers, and copolymers of the aforementioned monomers with other monomers.

Examples of vinyl aromatic monomers that may be included can include styrene, 3-methylstyrene, 4-methylstyrene, styrene-butadiene, p-chloromethylstyrene, 2-chlorostyrene, 3-chlorostyrene, 4-chlorostyrene, divinyl benzene, vinyl naphthalene and divinyl naphthalene. Vinyl halides can include, for example, vinyl chloride and vinylidene fluoride. Vinyl esters of carboxylic acids can include, for example, vinyl acetate, vinyl butyrate, vinyl methacrylate, vinyl 3,4-dimethoxybenzoate, vinyl maleate and vinyl benzoate. Examples of vinyl ethers can include butyl vinyl ether and propyl vinyl ether.

In some examples, the coating composition can include a styrene-butadiene based latex and no other latex may be present.

In certain examples, the coating composition can include a styrene-butadiene based latex such as Litex® PX 9710, Litex® 9720, Litex® 9730 or Litex® PX 9740, from Synthomer (Essex, UK). Additional latex types that may be added can include Gencryl® 9525, Gencryl® 9750, and Gencryl® 9780, from Omnova; STR 5401, from Dow Chemical Company (Midland, Mich.), or combinations thereof. In one example, the styrene-butadiene based latex can be carboxylated, e.g., Litex® PX 9740.

As mentioned above, in some examples the coating composition can include a high molecular weight polyvinyl alcohol having a weight average molecular weight of 150,000 Mw to 400,000 Mw. In further examples, the polyvinyl alcohol can have a weight average molecular weight of 190,000 Mw to 400,000 Mw. The polyvinyl alcohol can also act as a binder in addition to the latex mentioned above. In certain examples, the high molecular weight polyvinyl alcohol can be present in an amount from 1 wt % to 4 wt % by dry weight. In further examples, the high molecular weight polyvinyl alcohol can be present in an amount from 1 wt % to 2 wt % by dry weight. In some examples, depending on the other ingredients that may be present, the mechability of the coating compositions can be further increased by including a high molecular weight polyvinyl alcohol, such as polyvinyl alcohol having a weight average molecular weight of 150,000 Mw to 400,000 Mw. The high molecular weight polyvinyl alcohol can be used instead of a lower molecular weight polyvinyl alcohol, in whole or in part. In some cases, coating compositions for packaging liners may include latexes and cross-linkers to increase mechability as well. However, the higher molecular weight polyvinyl alcohols described herein can, in some examples, allow for a reduction in the amount of latex used and a reduction or elimination of the cross-linker used. Because latex and cross-linkers can sometimes be unpredictable and have negative impacts on coating compositions, removing the cross-linker and reducing the amount of latex can provide a coating composition that may be more consistent with less negative effects. Furthermore, in some examples, a low molecular weight polyvinyl alcohol, e.g., 20,000 Mw to 130,000 Mw, can be used along with the high molecular weight polyvinyl alcohol to adjust mechability levels. Thus, there can be a wide variety of polyvinyl alcohol molecular weights that can be used, including low molecular weight PVA, e.g., 20,000 Mw to 130,000 Mw admixed with high molecular weight PVA, e.g., 150,000 Mw to 400,000 Mw; or the high molecular PVA without other PVA molecular weight material. For example, a low molecular weight polyvinyl alcohol can be present at from 0.5 wt % to 3 wt % or from 0.5 wt % to 2 wt %, and a high molecular weight polyvinyl alcohol can be present at from 0.5 wt % to 3 wt % or from 0.5 wt % to 2 wt %. In another example, the total amount of polyvinyl alcohol, including both the high molecular weight and the low molecular weight polyvinyl alcohol, can be from 1 wt % to 6 wt % by dry weight.

In some examples, the high molecular weight polyvinyl alcohol can include Mowiol® 40-88 (205,000 Mw), Mowiol® 56-88 (195,000 Mw), and Poval™ 235 (precise molecular weight is unknown, but has a viscosity of 95 mPa·s, which corresponds to a molecular weight in the range of 150,000 Mw to 400,000 Mw), each from Kuraray (Houston, Tex.). In further examples, lower molecular weight polyvinyl alcohols can include Mowiol® 4-98 (27,000 Mw), Mowiol® 4-88 (31,000 Mw), Mowiol® 6-98 (47,000 Mw), and Mowiol® 18-88 (130,000 Mw), each from Kuraray (Houston, Tex.).

The coating composition can also include a cationic fixing agent. In some examples, the cationic fixing agent can include water-soluble mono-valent metallic salts or water-soluble multi-valent metallic salts, where the metallic salt includes (i) a cation of a metal such as a Group I metal, Group II metal, Group III metal, transition metal, or combination thereof, and (ii) an anion such as chloride, iodide, bromide, nitrate, sulfate, sulfite, phosphate, chlorate, acetate, chlorohydrate, and combinations thereof. Some examples of the cation can include sodium, calcium, copper, nickel, magnesium, zinc, barium, iron, aluminum, chromium, or combinations thereof. Some examples of the cationic fixing agent can include calcium chloride, magnesium chloride, calcium bromide, magnesium bromide, calcium nitrate, magnesium nitrate, aluminum chlorohydrate, or combinations thereof. In one example, the cationic fixing agent can be calcium chloride (CaCl₂).

In certain examples, the cationic fixing agent may be present in the coating composition in an amount ranging from 6 wt % to 15 wt % by dry weight based on the total dry weight of the coating composition.

In some examples, a reaction may take place between the cationic fixing agent and an anionic pigment in the ink (applied to the coated liner) to fix the anionic pigment. As such, image quality (e.g., bleed, coalescence, text quality, etc.) can be affected by the cationic fixing agent. In some examples, ink can be printed onto the coated liners described herein without applying any additional fixer fluid because the cationic fixing agent in the coating of the coated liner is sufficient to fix pigments in the ink.

In some cases, coating compositions may include plastic pigments to enhance gloss and/or durability. However, in some examples, the coating compositions described herein can be devoid of plastic pigments. In other examples, a plastic pigment may be present in the coating composition in an amount no greater than 0.1 wt % by dry weight. In some examples, removing the plastic pigment can reduce ink coalescence, resulting in better image quality. In certain examples, plastic pigments can include styrene based pigments and/or hollow sphere type polystyrene based pigments. In some examples, the plastic pigment can include Ropaque™ AF1055 from Dow Chemical, or Lytron™ HG80 from Omnova Solutions Inc.

In further examples, the coating composition may be devoid of wax particles. Some coating compositions may include wax particles to provide scratch and rub resistance, but in some examples the coating compositions described herein can achieve adequate scratch and rub resistance without wax particles. Removing the wax particles can also provide reduced ink coalescence. In further examples, the coating composition may contain wax particles in an amount no greater than 0.1 wt % by dry weight. In some examples, wax particles can include polypropylene wax, polyethylene wax, polytetrafluoroethylene wax, and the like. The polyethylene wax may be a high density wax or a low density wax. Examples of waxes can include Ultralube® D806 available from Keim-additec Surface GmbH (Kirchberg, Germany), Liquilube™ 405 from Lubrizol Advanced Materials, Inc., and waxes available from Micro Powders, Inc.

Beyond the coating compositions themselves, the present disclosure also extends to coated liners. In various examples, the coated liner can include a base liner and a coating applied to the base liner. The coating can be formed by applying the coating compositions described herein and allowing the coating to dry. The coating can be applied by any coating technique suitable for coating compositions having a viscosity of about 400 cp to 3,000 cp, such as blade coating or rod coating. In one example, the viscosity can be form about 600 cp to about 1800 cp, or in another example, from about 800 cp to about 1200 cp.

In certain examples, the coating layer on the coated liner can have a coat weight of 4 gsm to 20. In other examples, the coating layer can have a coat weight of 5 gsm to 15 gsm. In further examples, the coating layer can be formed as two separate layers that are coated consecutively to form a coating layer. In other examples, the coating layer can be formed as a single coating layer with a single application of the coating composition.

Any suitable type of base liner can be used to make the coated liners described herein. In certain examples, the base liner can be a Kraft liner, a white top liner, or a bleached liner. Kraft linerboard is typically brown, while white top liner board includes a white top surface on top of a brown Kraft base. Bleached liner board can be bleached white all the way through. Base liners can be defined as the liner material on corrugated packaging that is typically used for printing and/or labeling. A backing liner, on the other hand, can be defined as a liner that is used on the opposite side of a fluted medium to provide the corrugated packing structure on both sides of the fluted medium, e.g., the backing liner on one side and the base liner on the other side. In the context of the present disclosure, the base liner is the liner that is coated with the coating compositions described herein which provides a suitable surface for printing thereon, such as by inkjet printing. As a note, the backing liner can be modified similarly with a coating composition applied thereto as well, particularly when there may be utility to printing on both sides of the corrugated packaging.

In the case of white top liners, a white top liner can be made with a clay coating or a layer of white fibers on the top to produce a white appearance. In one example, bleached white fibers can be layered over brown fibers to make a white top liner. Uncoated white top liners can be made with a paper machine having multiple headboxes or otherwise capable of laying down multiple layers of fiber. The combination of layers of brown fibers with bleached white fibers can produce a stronger liner than all bleached fibers, and the cost can be reduced because the brown fibers are cheaper than bleached fibers.

In some examples, the coating composition described herein can be applied during the manufacturing process of the base liner. For example, the coating composition can be applied to a pulp of the base liner when the pulp includes more than 90% solids. The pulp and the coating composition can then be dried to remove liquid from the base liner and the coating layer, forming the coated liner. In other examples, a pre-made dry base liner can be coated with the coating composition.

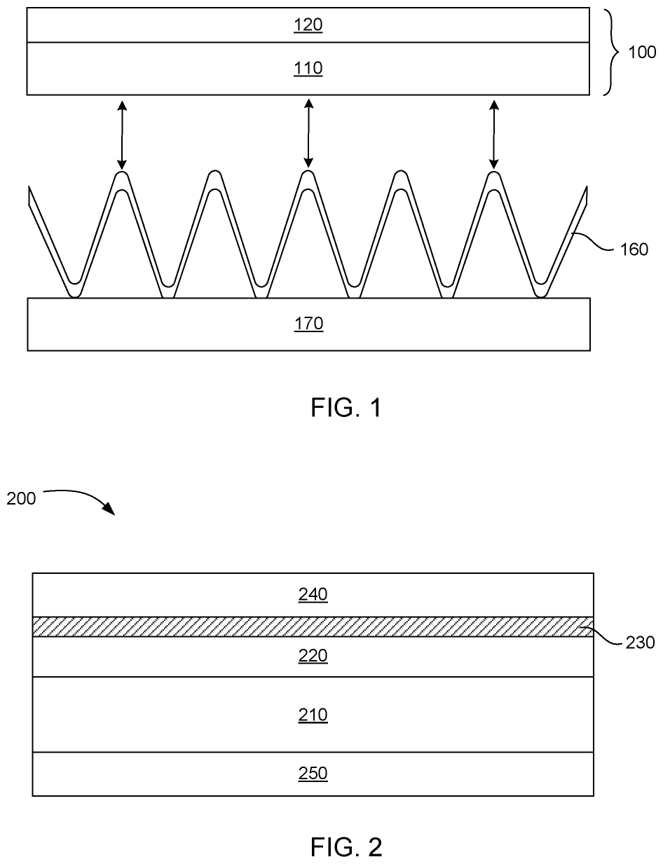

FIG. 1 shows a cross-sectional view of an example coated base liner 100 in accordance with an example of the present disclosure. The coated base liner includes a base liner 110 and a coating layer 120 on or applied to the base liner. In one example, the coated liner can be assembled as corrugated packaging by attaching the base liner to a fluted medium 160, which is also attached to a backing liner 170. The backing liner can be positioned opposite the base liner. In some examples, the fluted medium can be formed by pressing a moistened linerboard between geared wheels to form the fluting pattern. The fluted medium can then be glued between the coated liner and the backing liner. In certain examples, the backing liner can also be coated with the coating composition if printing on the backing liner is desired. In other examples, the corrugated packaging may be in the form of a box and the backing liner may be oriented toward the inside of the box where printing on the backing liner would not be visible. In such examples, the backing liner can be uncoated. The corrugated packing can also be arranged in other configurations suitable for packaging.

In certain examples, additional layers can be added to the coated liner during and after the printing process. For example, in some cases a layer of ink can be printed onto the coating layer to form a printed image, followed by a layer of overprint varnish to protect the printed image. In other examples, a curl control layer may be added to the back surface of the base liner to reduce curling of the printed liner. FIG. 2 shows an example coated liner 200 having a base liner 210, a coating layer 220, an ink layer 230, and overprint varnish layer 240, and a curl control layer 250. In certain examples, the curl control layer can include a starch. In further examples, the overprint varnish layer can include an overprint varnish such as Inxkote® AC911 or Inxkote® AC9116 from INX International; Aquaflex® H.R. from Flint Group; or Thermagloss® 1394E, Thermagloss® 426, Thermagloss® 425, Thermagloss® 475, Thermagloss® 460, or Digiguard® gloss 100 from Michelman. The fluted medium and backing liner are not shown in this example, but could be incorporated or attached to this coated liner similarly as that shown in FIG. 1.

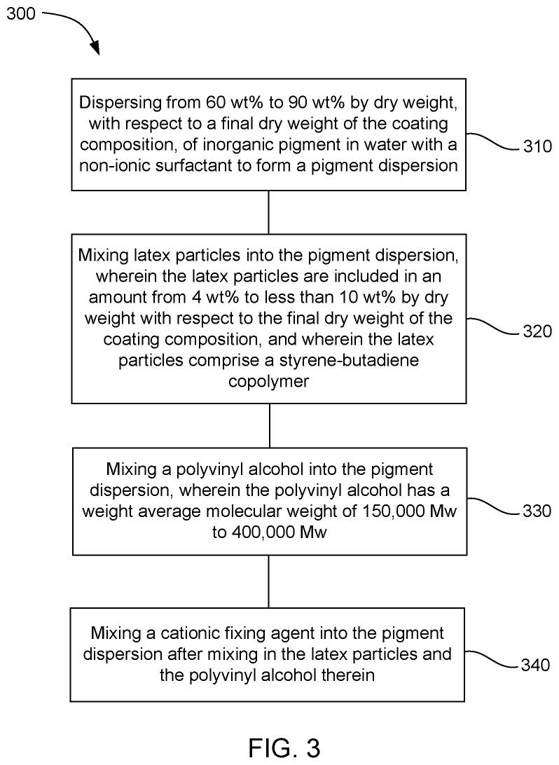

FIG. 3 shows a flowchart of an example method 300 of formulating a coating composition. The method includes dispersing 310 from 60 wt % to 90 wt % by dry weight, with respect to a final dry weight of the coating composition, of inorganic pigment in water and non-ionic surfactant to form a pigment dispersion; mixing 320 latex particles into the pigment dispersion, wherein the latex particles are included in an amount from 4 wt % to less than 10 wt % by dry weight with respect to the final weight of the coating composition, and wherein the latex particles include a styrene-butadiene copolymer; mixing 330 a polyvinyl alcohol into the pigment dispersion, wherein the polyvinyl alcohol has a weight average molecular weight of 150,000 Mw to 400,000 Mw; and mixing 340 a cationic fixing agent into the mixture after mixing in the latex particles and the polyvinyl alcohol. In certain examples, the rate of addition of the cationic fixing agent into the mixture can be slower than the rates of addition of the latex particles and the polyvinyl alcohol.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

The term “coated liner(s)” can refer to coated base liners in accordance with the present disclosure, and in some specific instances can also include coated backing liners.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the coating compositions, coated liners, and methods of formulating coating compositions, each of these discussions can be considered applicable to each of these examples, whether or not they are explicitly discussed in the context of that example. Thus, for example, in discussing details about the coating compositions, such discussion also refers to the methods and the coated liners described herein, and vice versa.

### EXAMPLES

### Example 1—Comparison of Polyvinyl Alcohols

A series of coating compositions 1-8 were formulated with the compositions shown in Table 1 based on dry parts by weight. As shown in the table, the coating compositions included identical ingredients with the exception of the polyvinyl alcohol. The polyvinyl alcohol was varied by including multiple different types of polyvinyl alcohol in multiple different amounts in the coating compositions. The particular polyvinyl alcohols used in these examples had the trade name Mowiol®. The Mowiol® polyvinyl alcohols are identified according to their viscosity and their degree of hydrolysis. In the name of polyvinyl alcohol, Mowiol® is followed by two numbers. The first number is the viscosity in mPa·s of a 4% aqueous solution of the polyvinyl alcohol at 20° C. The second number is the degree of hydrolysis. These polyvinyl alcohols are manufactured by hydrolyzing polyvinyl acetate, and the degree of hydrolysis refers to the percentage of acetate groups that have been hydrolyzed to alcohol groups.

The molecular weight of the polyvinyl alcohol correlates to the viscosity of the polyvinyl alcohol solutions. In these particular examples, the polyvinyl alcohols have the following weight average molecular weights: Mowiol® 4-98: 27,000 Mw; Mowiol® 6-98: 47,000 Mw; Mowiol® 18-88: 130,000 Mw; Mowiol® 40-88: 205,000 Mw; Mowiol® 56-88: 195,000 Mw.

The coating compositions were coated on a white top liner at a coat weight of 15 gsm and the mechability was ranked. The mechability rankings were found by printing a strip of violet made by combining magenta and cyan ink at a coat weight of 15 gsm onto the coated liner. The ink was dried at 375° F. for 3 seconds and then an aluminum roller heated to 100° C. was rolled directly over the print for three passes. Moving the roller back and forth counted as one pass. The results were then visually compared. The mechability was ranked based on the frequency of ink removal spots and the visual damage to the print strip. A higher mechability ranking indicates better mechability, with 5 being the best ranking. The results show that examples 3 and 4 had the best mechability with 4 parts by dry weight of Mowiol® 18-88 and Mowiol® 40-88. A coating composition with 4 parts by weight of Mowiol® 56-88 was also tested (not shown in table) and also scored 5 on the mechability test. Examples 6-8 show that when the amount of polyvinyl alcohol is reduced to 2 parts by dry weight, the Mowiol® 40-88 and Mowiol® 56-88 provide good mechability while the Mowiol® 18-88 provides poorer mechability.

TABLE 1

| | Coating Composition Nos. | | | | | | | |
|---|---|---|---|---|---|---|---|---|
| | (Dry parts by weight) | | | | | | | |
| Ingredients | 1 | 2 | 3 | 4 | 5 | 6 | 7 | 8 |
| Hydrocarb ® 90 | 80 | 80 | 80 | 80 | 80 | 80 | 80 | 80 |
| Kaocal ® | 20 | 20 | 20 | 20 | 20 | 20 | 20 | 20 |
| Disponil ® AFX 4050 | 0.3 | 0.3 | 0.3 | 0.3 | 0.3 | 0.3 | 0.3 | 0.3 |
| Litex ® PX9740 | 8 | 8 | 8 | 8 | 8 | 8 | 8 | 8 |
| Mowiol ® 4-98 (27,000 Mw) | 4 | — | — | — | — | — | — | — |
| Mowiol ® 6-98 (47,000 Mw) | — | 4 | — | — | 2 | — | — | — |
| Mowiol ® 18-88 (130,000 Mw) | — | — | 4 | — | — | 2 | — | — |
| Mowiol ® 40-88 (205,000 Mw) | — | — | — | 4 | — | — | 2 | — |
| Mowiol ® 56-88 (195,000 Mw) | — | — | — | — | — | — | — | 2 |
| CaCl₂ | 7 | 7 | 7 | 7 | 7 | 7 | 7 | 7 |
| Mechability Ranking: | 2 | 2 | 5 | 5 | 1.5 | 3 | 4 | 5 |

Hydrocarb ® 90 is ultrafine ground calcium carbonate from Omya North America; Kaocal is a calcined clay from Thiele Kaolin Company; Disponil ® 4030 AFX is a fatty alcohol polyglycol ether surfactant from BASF; Litex ® PX9740 is a styrene butadiene-based latex from Synthomer; and Mowiol ® polymers are polyvinyl alcohols from Kuraray.

### Example 2—Decreasing Amount of Polyvinyl Alcohol

A similar experiment was performed with the coating compositions 9-15 shown in Table 2 based on dry parts by weight. In this example, the coating compositions were coated as a two layer coating, with each of the two layers having a coat weight of 10 gsm for a total coat weight of 20 gsm. The same mechability test was then performed as in Example 1. These examples also shown that Mowiol® 40-88 and Mowiol® 56-88 provide better mechability when the amount of polyvinyl alcohol is reduced to 2 or 3 parts by dry weight.

TABLE 2

| | Coating Composition Nos. | | | | | | |
|---|---|---|---|---|---|---|---|
| | (Dry parts by weight) | | | | | | |
| Ingredients | 9 | 10 | 11 | 12 | 13 | 14 | 15 |
| Hydrocarb ® 90 | 80 | 80 | 80 | 80 | 80 | 80 | 80 |
| Kaocal ® | 20 | 20 | 20 | 20 | 20 | 20 | 20 |
| Disponil ® AFX 4050 | 0.3 | 0.3 | 0.3 | 0.3 | 0.3 | 0.3 | 0.3 |
| Litex ® PX9740 | 8 | 8 | 8 | 8 | 8 | 8 | 8 |
| Mowiol ® 6-98 (47,000 Mw) | 4 | 2 | — | — | — | — | — |
| Mowiol ® 18-88 (130,000 Mw) | — | — | 3 | — | 2 | — | — |
| Mowiol ® 40-88 (205,000 Mw) | — | — | — | 3 | — | 2 | — |
| Mowiol ® 56-88 (195,000 Mw) | — | — | — | — | — | — | 2 |
| CaCl₂ | 7 | 7 | 7 | 7 | 7 | 7 | 7 |
| Mechability Ranking: | 2 | 1.5 | 4 | 5 | 3 | 4 | 5 |

### Example 3—Mixtures of High and Low Molecular Weight Polyvinyl Alcohol

A similar experiment was performed with the coating compositions 16-19 shown in Table 3 based on dry parts by weight. Example 19 includes the polyvinyl alcohol Poval™ 235. The molecular weight of Poval™ 235 was unknown, but the viscosity was 95 mPa·s, which corresponds to a molecular weight in the range of 150,000 Mw to 400,000 Mw. In this example, the coating compositions were coated as a two layer coating, with each of the two layers having a coat weight of 10 gsm for a total coat weight of 20 gsm. The same mechability test was then performed as in Example 1.

TABLE 3

| | Coating Composition Nos. | | | |
|---|---|---|---|---|
| | (Dry parts by weight) | | | |
| Ingredients | 16 | 17 | 18 | 19 |
| Hydrocarb ® 90 | 80 | 80 | 80 | 80 |
| Kaocal ® | 20 | 20 | 20 | 20 |
| Disponil ® AFX 4050 | 0.3 | 0.3 | 0.3 | 0.3 |
| Litex ® PX9740 | 8 | 8 | 8 | 8 |
| Mowiol ® 6-98 (47,000 Mw) | 4 | 1 | 1 | 1 |
| Mowiol ® 18-88 (130,000 Mw) | — | 2 | — | — |
| Mowiol ® 40-88 (205,000 Mw) | — | — | 2 | — |
| Poval ™ 235 * | — | — | — | 2 |
| CaCl₂ | 7 | 7 | 7 | 7 |
| Mechability Ranking: | 2 | 4 | 5 | 5 |

* Poval ™ 235 is available from Kuraray. The molecular weight of Poval ™ 235 was unknown, but the viscosity was 95 mPa · s, which corresponds to a molecular weight in the range of 150,000 Mw to 400,000 Mw.

It can be seen from Tables 1-3 that the mechability tends to be better with polyvinyl alcohols having a weight average molecular weight from 150,000 to 400,000 as well as with increasing amounts of polyvinyl alcohol. However, when polyvinyl alcohol of 150,000 to 400,000 Mw is used, a smaller amount can be used to achieve better mechability than a larger amount of the polyvinyl alcohol having a molecular weight below 150,000 Mw. Additionally, a mixture of polyvinyl alcohol having a molecular weight of 20,000 Mw to 130,000 Mw with a polyvinyl alcohol having a molecular weight of 150,000 to 400,000 can be used achieve good mechability as shown in examples 18 an 19.

### Example 4—Type of Latex

A separate experiment was performed to compare two styrene-butadiene based latexes: Litex® PX9740 (available from Synthomer plc) and XZ 94378 (available from Trinseo UK Limited). Styrene-butadiene based latexes were selected as binders for the present coating compositions because of their cohesive and adhesive strength, flexibility, durability, and dimensional stability properties. They are also effective for use with coating compositions with high solids or filler content, and can provide good coalescence. As the compositions of the present disclosure include from 60 wt % to 90 wt % inorganic pigment, styrene-butadiene polymer latex can be used effectively compared to other types of latexes, such as some acrylic latexes, for example.

Two coating compositions (20 and 21) were formulated having the compositions shown in Table 4. These coatings were coated at a coat weight of 15 gsm on a white top liner. The coalescence of ink printed on the coatings was tested using the following procedure. Squares of ink ranging in ink density from 4% to 100% were printed in a strip on the coated liners. Cyan ink was selected because the chosen cyan ink tends to show the worst visible coalescence. After a 5 or 30 second drying time under a 375° F. dryer, the strip was scanned and analyzed using software to calculate the coalescence in each square of the strips. The square with the highest coalescence value was reported to measure coalescence differences between the two coating compositions. The lower coalescence values are better (i.e., less coalescence). A difference of about 0.3 to 0.5 is noticeable to the naked eye.

TABLE 4

Coating Composition Nos.
(Dry parts by weight)

| Ingredients | 20 | 21 |
|---|---|---|
| Hydrocarb ® 90 | 80 | 80 |
| Kaocal ® | 20 | 20 |
| Disponil ® AFX 4030 | 0.3 | 0.3 |
| Litex ® PX9740* | 8 | — |
| XZ 94378 | — | 8 |
| Mowiol ® 6-98 (47,000 Mw) | 4 | 4 |
| CaCl₂ | 7 | 7 |
| Coalescence Value: | 2 | 2.7 |

XZ 94378 is a styrene-butadiene copolymer available from Trinseo UK Limited;
*Litex ® PX9740 includes a carboxylated styrene-butadiene copolymer.

It can be seen from Table 4 that when all other ingredients are the same, both styrene-butadiene based latex provided acceptable coalescence. The Litex® PX9740, which includes a carboxylated styrene-butadiene copolymer, provided the best coalescence out of the two latexes tested. These formulations did not include a high molecular weight polyvinyl alcohol, but rather were formulated to evaluate coalescence provided by the latexes.

### Example 5—Plastic Pigment and Wax

A separate experiment was performed to evaluate the effect of plastic pigment and wax particles. Coating compositions 22-25 were formulated with the compositions shown in Table 5 based on dry parts by weight. These coating compositions were then coated on both white top and bleached liners at a coat weight of 10 gsm. The coalescence of ink printed on the coated liners was then tested using the procedure of Example 4.

TABLE 5

| | Coating Composition Nos. | | | |
|---|---|---|---|---|
| | (Dry parts by weight) | | | |
| Ingredients | 22 | 23 | 24 | 25 |
| Hydrocarb ® 90 | 80 | 80 | 80 | 80 |
| Kaocal ® | 20 | 20 | 20 | 20 |
| Dispex ® N-40V | 0.3 | 0.3 | 0.3 | 0.3 |
| Litex ® PX9740 | 10 | 10 | 10 | 10 |
| Mowiol ® 4-98 (27,000 Mw) | 5 | 4 | 1.25 | 1 |
| Ultralube ® D806 | — | 2 | — | 2 |
| Rhopaque ® AF 1055 | — | 6 | — | 6 |
| CaCl₂ | 5 | 5 | 5 | 5 |
| Coalescence (Bleached Liner) | 3.5 | 4.3 | 3 | 4.3 |
| Coalescence (White Top Liner) | 2.7 | 3.9 | 2.5 | 3.6 |

Ultralube ® D806 is a wax available from Keim-additec Surface GmbH; and Rhopaque ® AF 1055 are styrene acrylic hollow sphere polymeric pigments.

It can be seen from Table 5 that the coalescence was better in each case when the wax (Ultralube® D806) and the plastic pigment (Rhopaque® AF 1055) were not included. These formulations did not include a high molecular weight polyvinyl alcohol, but rather were formulated to evaluate the impact of wax and/or plastic pigment on coalescence.

### Example 6—Corrugated Packaging Assembly

A fluted medium, such as that shown at 160 in FIG. 1, is prepared by pressing a moistened linerboard between laterally elongated geared wheels to form a fluting pattern. The fluted medium is glued between a backing liner and a base liner coated with one of Coating Composition Nos. 3, 4, 6-8, 11-15, 17-19 The backing liner may or may not also be coated with one of a coating composition of the present disclosure or some other coating composition. The corrugated packaging, now assembled, can be further configured in the form of a box with the backing liner oriented toward the inside of the box.

While the disclosure has been described with reference to certain examples, various modifications, changes, omissions, and substitutions can be made without departing from the spirit of the disclosure. It is intended, therefore, that the disclosure be limited by the scope of the following claims.

What is claimed is:

1. A coating composition, comprising:
from 60 wt % to 90 wt % by dry weight inorganic pigment;
a non-ionic surfactant;
latex particles in an amount of 4 wt % to less than 10 wt % by dry weight, wherein the latex particles comprise a styrene-butadiene copolymer;
a polyvinyl alcohol having a weight average molecular weight of 150,000 Mw to 400,000 Mw; and
a cationic fixing agent.

2. The coating composition of claim 1, wherein the inorganic pigment is present in an amount from 70 wt % to 90 wt % by dry weight, the polyvinyl alcohol is present in an amount from 1 wt % to 4 wt % by dry weight, and the cationic fixing agent is present in an amount from 6 wt % to 15 wt % by dry weight.

3. The coating composition of claim 1, wherein the polyvinyl alcohol is present in an amount from 1 wt % to 2 wt % by dry weight.

4. The coating composition of claim 1, further comprising a second polyvinyl alcohol having a weight average molecular weight of 20,000 Mw to 130,000 Mw in an amount from 0.5 wt % to 2 wt % by dry weight.

5. The coating composition of claim 1, wherein the styrene-butadiene copolymer of the latex particles is a carboxylated styrene-butadiene copolymer.

6. The coating composition of claim 1, wherein the coating composition does not comprise a plastic pigment or a wax.

7. The coating composition of claim 1, wherein the non-ionic surfactant comprises a fatty alcohol polyglycol ether.

8. A coated liner for corrugated packaging, comprising:
a base liner; and
a coating layer on the base liner, the coating layer including:
an inorganic pigment,
a non-ionic surfactant,
latex particles in an amount of 4 wt % to less than 10 wt % by dry weight wherein the latex particles comprise a styrene-butadiene copolymer,
a polyvinyl alcohol having a weight average molecular weight of 150,000 Mw to 400,000 Mw, and
a cationic fixing agent.

9. The coated liner of claim 8, wherein the coated liner is attached a fluted medium opposite a backing liner.

10. The coated liner of claim 8, wherein the coating layer has a coat weight of 4 gsm to 20 gsm.

11. The coated liner of claim 8, wherein the coating layer is a single coating layer without a second coating layer applied thereon.

12. The coated liner of claim 8, wherein the inorganic pigment is present in an amount from 70 wt % to 90 wt % by dry weight, the polyvinyl alcohol is present in an amount from 1 wt % to 4 wt % by dry weight, and the cationic fixing agent is present in an amount from 6 wt % to 15 wt % by dry weight with respect to the weight of the coating layer.

13. A method of formulating a coating composition, comprising:
dispersing from 60 wt % to 90 wt % by dry weight, with respect to a final dry weight of the coating composition, of inorganic pigment in water with a non-ionic surfactant to form a pigment dispersion;
mixing latex particles into the pigment dispersion, wherein the latex particles are included in an amount from 4 wt % to less than 10 wt % by dry weight with respect to the final weight of the coating composition, and wherein the latex particles comprise a styrene-butadiene copolymer;
mixing a polyvinyl alcohol into the pigment dispersion, wherein the polyvinyl alcohol has a weight average molecular weight of 150,000 Mw to 400,000 Mw; and
mixing a cationic fixing agent into the pigment dispersion after mixing in the latex particles and the polyvinyl alcohol therein.

14. The method of claim 13, wherein the inorganic pigment is included in an amount from 70 wt % to 90 wt % by dry weight, the polyvinyl alcohol is included in an amount from 1 wt % to 4 wt % by dry weight, and the cationic fixing agent is included in an amount from 6 wt % to 15 wt % by dry weight, based on the final dry weight of the coating composition.

15. The method of claim 14, wherein a rate of addition of the cationic fixing agent into the mixture is slower than rates of addition of the latex particles and the polyvinyl alcohol.
